(19) United States
(12) Patent Application Publication
(10) Pub. No.: US 2014/0251020 A1
(43) Pub. Date: Sep. 11, 2014

(54) METHOD AND APPARATUS FOR PIPE PRESSURE MEASUREMENTS

(71) Applicants: Henry P. OFFER, San Jose, CA (US); Khaled M. EWIDA, Dallas, TX (US); Glenn SCHROEDER, Wilmington, NC (US); Mike NEIHEISEL, Troy, MI (US); Rabah HADJIT, Ann Arbor, MI (US); Joel C. SCHNACKENBERG, Charlevoix, NC (US)

(72) Inventors: Henry P. OFFER, San Jose, CA (US); Khaled M. EWIDA, Dallas, TX (US); Glenn SCHROEDER, Wilmington, NC (US); Mike NEIHEISEL, Troy, MI (US); Rabah HADJIT, Ann Arbor, MI (US); Joel C. SCHNACKENBERG, Charlevoix, NC (US)

(73) Assignee: GE-Hitachi Nuclear Energy Americas LLC, Wilmington, NC (US)

(21) Appl. No.: 13/785,149

(22) Filed: Mar. 5, 2013

(51) Int. Cl. G01L 9/04

(52) U.S. Cl. CPC G01L 9/04
USPC 73/720; 29/525.08

(57) ABSTRACT

A strain gauge collar includes at least one strain gauge installed on a base and at least one clamp on the base. The at least one clamp is configured to attach the strain gauge collar to a main steam line (MSL) as a single unit.

### BACKGROUND

1. Field

Some example embodiments relate generally to a method and/or apparatus for pipe pressure measurements, and more particularly to a method and/or apparatus for pipe pressure measurements that reduce installation and exposure time for the operators of a nuclear facility.

2. Related Art

A reactor pressure vessel (RPV) of a nuclear reactor such as a boiling water reactor (BWR) typically has a generally cylindrical shape and is closed at both ends, e.g., by a bottom head and a removable top head. A top guide typically is spaced above a core plate within the RPV. A core shroud, or shroud, typically surrounds the reactor core and is supported by a shroud support structure. The shroud has a generally cylindrical shape and surrounds both the core plate and the top guide. There is a space or annulus located between the cylindrical reactor pressure vessel and the cylindrically-shaped shroud.

Heat is generated within the core and water circulated up through the core is at least partially converted to steam. Steam separators separate the steam and the water. Residual water is removed from the steam by steam dryers located above the core. The de-watered steam exits the RPV through a steam outlet near the vessel top head.

Conventional BWRs can experience damage resulting from aero-acoustic loading of the steam dryer during operation. Some conventional BWRs have experienced significant degradation of the steam dryer after operating at power levels in excess of the original licensed thermal power. For example, the aero-acoustic loading of the steam dryer can result in vibration of the steam dryer during operation, which may manifest as unusual wear or in some cases cracking of steam dryer components.

Steam dryer damage can prevent the plant from operating at a desired power level. Further, costs (time, money, etc.) associated with repairs to the steam dryer can be significant. Accordingly, it is desirable to be able to predict the nature of acoustic loads expected on a BWR steam dryer.

In order to predict the nature of the acoustic loads expected on BWR steam dryers, in-plant data may be obtained at a desired power level from strain gauges directly welded to the main steam line (MSL) in order to measure the internal dynamic and static pressures thereof.

However, this approach may require substantial on-site installation efforts that result in moderate levels of dose exposure for operators of a nuclear facility.

### SUMMARY

Some example embodiments provide a method and/or apparatus for pipe pressure measurements using a strain gauge collar that reduces the installation and exposure time for operators of a nuclear facility. Other example embodiments provide a method and/or apparatus for pipe pressure measurements that allows for reduced labor costs and the accuracy of the system to be maintained or improved.

An example embodiment of a strain gauge collar includes at least one strain gauge installed on a base and at least one clamp on the base. The at least one clamp is configured to attach the strain gauge collar to a main steam line (MSL) as a single unit.

An example embodiment of a pressure vessel includes a feedwater line connected to a reactor, a main steam line (MSL) connected to the reactor, and a strain gauge collar on the MSL. The strain gauge collar includes at least one strain gauge installed on a base and at least one clamp on the base. The strain gauge collar is attached to the MSL as a single unit.

An example embodiment of a method of fabricating a strain gauge collar includes installing at least one strain gauge on a base and attaching the base to a main steam line (MSL) as a single unit using at least one clamp.

An example embodiment of a method of fabricating a pressure vessel includes connecting a feedwater line to a reactor, connecting a main steam line (MSL) to the reactor, and installing a strain gauge collar on the MSL. At least one strain gauge is installed on a base and the base is attached to a main steam line (MSL) as a single unit using at least one clamp.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates a strain gauge collar in accordance with an example embodiment; and

FIG. 2 illustrates an example boiling water reactor (BWR) including the strain gauge collar, in accordance with another example embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments are directed to a main steam line (MSL) pressure measurement system using strain gauges welded to a removable collar to work as an integral part in a Plant Based Load Evaluation (PBLE). An analytical model can be obtained using PBLE to predict acoustic loads on a steam dryer from pressure data obtained from the main steam line strain gauges attached to a reactor pressure vessel (RPV).

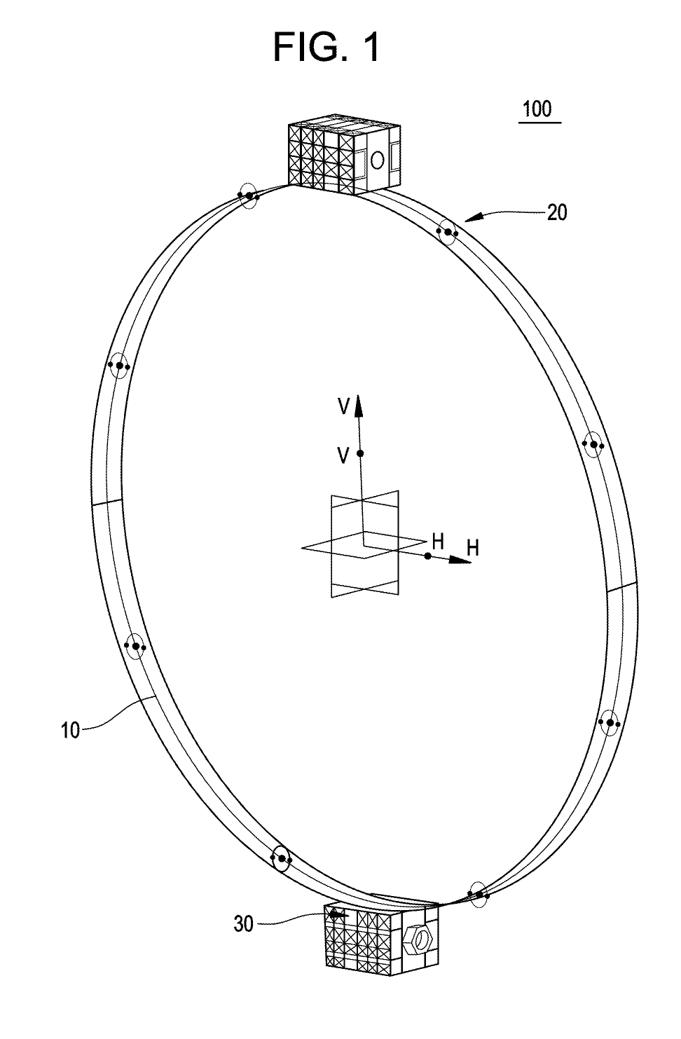

FIG. 1 illustrates a strain gauge collar 100, in accordance with an example embodiment. The strain gauge collar 100 includes a base 10, strain gauges 20, and clamps 30. The strain gauges 20 are arranged circumferentially on the base 10. The spacing between each gauge is at least 45°. All of the strain gauges 20 are 350 ohm measurement devices. The strain gauges 20 arranged on the base 10 measure the internal dynamic hoop stress of the MSL, which are then converted to fluctuating pressure. In other words, the strain gauge collar 100 is used to measure the internal dynamic pressure of the MSLs.

The strain gauges 20 may be preinstalled on the base 10, and then installed as one unit on the MSL to measure the internal dynamic and static pressures of the MSL. The dynamic and static pressures are used as input in the analysis for the prediction of fluctuating pressure loads on a steam dryer (not shown). The base 10 and the clamps 30 are made of a stainless steel alloy, e.g., 17-4PH, Condition H1150. The strain gauges 20 are made up of an assembly of various materials, e.g., shims, insulators, wires, a shield, etc. The shims may be made of a transition metal alloy, e.g., HASTELLOY® X (manufactured by Haynes International Inc.), the insulators may be made of a ceramic material, the wires may be made of a metal such as copper or tin, the shield may be made of stainless steel, and fiberglass sheathing may be formed around the wires.

The base 10 includes at least two K-type thermocouples (not shown) located adjacent to one of the clamps 30. The at least two K-type thermocouples allow for an accurate temperature reading of the strain gauge measurement area to be obtained. The strain gauges have an apparent strain curve, e.g., the measurements deviate with temperature. After obtaining the temperature, this apparent strain curve can be applied to the strain gauge measurement to improve the strain measurement error. The at least two K-type thermocouples may include chromel and alumel alloys. The clamps 30 allow for the strain gauge collar 100 to be attached to the MSL.

As the strain gauges 20 are preinstalled on the base 10, rather than each being directly welded to a RPV such as a boiling water reactor (BWR), the installation of the strain gauges on the base 10 can take place apart from the RPV, which reduces dose exposure for operators of a nuclear facility and reduces the cost and time required for installation.

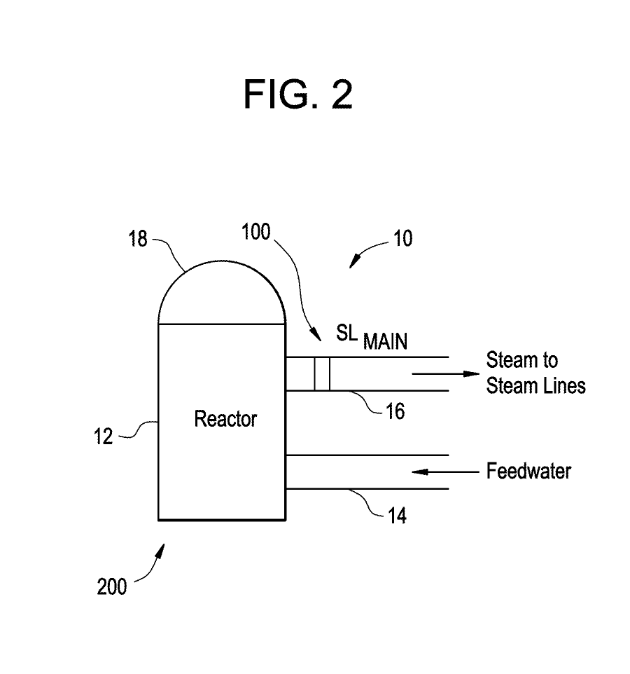

FIG. 2 illustrates an example boiling water reactor (BWR) 200 including the strain gauge collar, in accordance with another example embodiment.

Referring to FIG. 2, a pressure vessel, e.g., a boiling water reactor (BWR) 200, includes a reactor 12 having a dome 18, a feedwater line 14, a strain gauge collar 100 and a main steam line (MSL) 16. Water provided via the feedwater line 14 is boiled within the reactor 12 to produce steam. More specifically, water is circulated through a reactor core (not shown) and heat is transferred to the water from fuel assemblies or bundles (not shown). The steam rises to the upper part or dome 18 of the reactor 12, where steam separators (not shown) remove water from the steam. The steam flows from the reactor 12 through a main steam line 16 and is subsequently divided to flow through a plurality of steam lines (not shown). The steam lines direct the steam through turbines of electric generators to produce electricity. The steam undergoes a cooling process and is condensed back into water to again cycle through the BWR 200.

At least one strain gauge collar 100 is installed on the MSL 16 to measure the internal dynamic and static pressures of the MSL, and then converting the obtained measurement to fluctuating pressure. The information provided by the strain gauge collar 100 is then used in the analysis for the prediction of fluctuating pressure loads on the steam dryer (not shown).

A strain gauge collar apparatus used in pipe pressure measurements of an example embodiment reduces the installation and exposure time for operators of a nuclear facility. Furthermore, according to an example embodiment, a method for pipe pressure measurements allows for reduced labor costs and improved measurements.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A strain gauge collar comprising:
at least one strain gauge installed on a base; and
at least one clamp on the base, the at least one clamp configured to attach the strain gauge collar to a main steam line (MSL) as a single unit.

2. The strain gauge collar of claim 1, wherein the at least one strain gauge is a plurality of strain gauges arranged circumferentially on the base.

3. The strain gauge collar of claim 2, wherein the spacing between each of the plurality of strain gauges is 45° or more.

4. The strain gauge collar of claim 2, wherein the plurality of strain gauges are 350 ohm measurement devices.

5. The strain gauge collar of claim 1, wherein the base and the at least one clamp are made of a stainless steel alloy.

6. A pressure vessel comprising:
a feedwater line connected to a reactor;
a main steam line (MSL) connected to the reactor; and
a strain gauge collar on the MSL, the strain gauge collar including at least one strain gauge and at least one clamp installed on a base, the at least one clamp attaching the strain gauge collar to the MSL as a single unit.

7. A method of fabricating a strain gauge collar, the method comprising:
installing at least one strain gauge on a base;
attaching the base to a main steam line (MSL) as a single unit using at least one clamp.

8. The method of claim 7, wherein the installing installs a plurality of strain gauges circumferentially on the base.

9. The method of claim 8, wherein the installing installs each of the plurality of strain gauges spaced apart by 45° or more.

10. A method of fabricating a pressure vessel, the method comprising:
connecting a feedwater line to a reactor;
connecting a main steam line (MSL) to the reactor;
installing at least one strain gauge and at least one clamp on a base to form a strain gauge collar; and
attaching the strain gauge collar to the MSL as a single unit using the at least one clamp.
